(19) United States
(12) Patent Application Publication
(10) Pub. No.: US 2025/0146582 A1
(43) Pub. Date: May 8, 2025

(54) WATER PURIFIER

(71) Applicant: COWAY Co., Ltd., Gongju-si (KR)

(72) Inventors: Si Jun PARK, Seoul (KR); Seung Yong LEE, Seoul (KR); Byong Hyeok LEE, Seoul (KR)

(73) Assignee: COWAY Co., Ltd., Gongju-si (KR)

(21) Appl. No.: 18/934,293

(22) Filed: Nov. 1, 2024

(30) Foreign Application Priority Data
Nov. 3, 2023 (KR) 10-2023-0150609

(51) Int. Cl. F16K 5/10; C02F 1/00

(52) U.S. Cl. CPC F16K 5/10; C02F 1/001; C02F 2201/004; C02F 2201/005

(57) ABSTRACT

A water purifier including: a filter unit for filtering raw water to provide purified water; a flow channel that provides a passage through which raw water or purified water flows; a valve unit including at least one valve module that is selectively opened and closed to control the flow of raw water or purified water in the flow channel; a cock for discharging the purified water to the outside; a housing including a first housing in which the filter unit, flow channel, and valve unit are arranged, and a second housing disposed on the front side of the first housing; and a cock support member that is detachably engaged with the cock and the housing.

### TECHNICAL FIELD

The present disclosure relates to a water purifier.

### BACKGROUND

In general, a water purifier is a device that receives raw water from a water source such as a water supply, filters the raw water through a filter provided inside, and provides purified water to the user.

Additionally, the purified water can be provided to the user as cold water, which is cooled to a predetermined temperature or lower, or as hot water, which is heated to a predetermined temperature or higher by the water purifier.

Conventional water purifiers may include a cock, which is a member for discharging purified water to the outside.

Meanwhile, to assemble the cock in a water purifier, two methods have traditionally been used: assembling the cock into a faucet or assembling the cock into the front housing.

In this regard, Korean Patent Publication No. 10-2011-0033722, titled “fluid extracting apparatus for water purifier which is capable of adjusting amount of extracting” (Patent Document 1) by the applicant, discloses a water purifier in which the cock is configured to connect with the body portion.

However, Patent Document 1 only discloses the connection between the cock and the body portion and does not address the prevention of gaps between the cock and the housing. In other words, the cock in Patent Document 1 creates a gap between the body portion and the cock, which may allow steam to enter the water purifier through the gap between the housing and the cock when hot water is extracted.

Additionally, Korean Patent Publication No. 10-2018-0133611, titled “faucet for water purifier” (Patent Document 2), discloses a faucet member with a water discharge pipe member installed. Patent Document 2 discloses that a separate water discharge pipe member and faucet member are assembled to provide a path for water discharge.

However, when the water discharge pipe member and the faucet member are assembled as in Patent Document 2, an assembly gap may occur. Furthermore, Patent Document 2 only discloses the assembly of the water discharge pipe member and the faucet member, but it does not suggest or disclose that the water discharge the pipe member or the faucet member should be assembled to prevent a gap between the housing of the water purifier and the components. Therefore, Patent Document 2 has the problem that steam generated during the discharge of hot water can enter the water purifier through gaps between the water discharge pipe member and the faucet member.

Moreover, Korean Patent Publication No. 10-2019-0024758, titled “a water purifier having output member enable common using of cold and warmth water purifier” (Patent Document 3) by Picogram Co., Ltd., discloses O-rings that seal the outer circumference of the water outlet cock and the inner circumference of the outlet-side coupling hole of the water purifier cover to prevent steam from scattering due to the discharge of hot water from the outlet cock.

However, the sealing achieved by the O-rings in Patent Document 3 may not be effective due to corrosion of the O-rings. Particularly, the outer circumference of the outlet cock housing in Patent Document 3 closely contacts the decorative cover of the water purifier, and the inner circumference of the outlet cock housing closely contacts the outlet cock. In this case, the likelihood of a gap occurring between the inner and outer circumferences of the outlet cock housing increases.

First, in Patent Document 3, the two areas that are in close contact face each other as the inner and outer sides, where the strong bonding of one can induce the separation of the other. Additionally, if the positional relationship between the decorative cover and the outlet cock is misaligned before assembly, improper coupling may occur. Furthermore, the sealing areas dependent on the O-rings are narrow, limited to the thickness of the decorative cover and the end of the outlet cock, which may result in gaps even due to small factors. If the outlet cock housing is designed to minimize gaps, fitting may become difficult due to manufacturing tolerances, particularly at least part of the outer or inner circumference. In other words, even if O-rings are placed at the connection points of the components as in Patent Document 3, gaps may remain in at least part of the outer and inner circumferences, allowing steam generated during hot water discharge to enter the water purifier through these gaps.

### PRIOR ART DOCUMENT

### Patent Document

(Patent Document 1) Korean Patent Application Publication No. 10-2011-0033722 (Published on Mar. 31, 2011)
(Patent Document 2) Korean Patent Application Publication No. 10-2018-0133611 (Published on Dec. 17, 2018)
(Patent Document 3) Korean Patent Application Publication No. 10-2019-0024758 (Published on Mar. 8, 2019)

### SUMMARY

In view of the above, the present disclosure provides a water purifier in which the cock support member closely contacts the cock and the housing, thereby preventing steam from entering between the cock and the housing.

An embodiment of the present invention prevents gaps by allowing the cock support member to engage with the cock and housing in a detachable manner, thereby preventing steam from entering the water purifier.

Additionally, an embodiment of the present invention provides a more effective prevention of steam entering the water purifier due to gaps between the cock and housing by allowing the cock support member to make wide contact with the bottom surface of the housing.

Furthermore, an embodiment of the present invention features a cock contact portion formed on the cock support member, which provides an effective adhesion to the cock.

Additionally, an embodiment of the present invention includes an O-ring, which enhances the sealing between the cock and the cock support member, ensuring a tighter seal.

Moreover, in an embodiment of the present invention, the shape of the cock support member is designed to engage with the specific shape of the cock, thereby providing a tighter seal between the cock and the cock support member.

In accordance with a first embodiment of the present disclosure, there is provided a water purifier including; a filter unit that filters raw water to provide purified water; a flow channel that provides a passage through which the raw water or the purified water flows; a valve unit including at least one valve module that is selectively opened and closed to control a flow of the raw water or the purified water in the flow channel; a cock for discharging the purified water to an outside of the water purifier; a housing including a first housing in which the filter unit, the flow channel, and the valve unit are accommodated, and a second housing disposed on a front side of the first housing; and a cock support member that is detachably engaged with the cock and the housing.

Further, in the water purifier, wherein the cock support member includes: a cock support body; and a cock support engagement part supported by the cock support body and having a housing engagement part that is formed to engage with the second housing, wherein the cock support body closely contacts the second housing when the second housing engages with the housing engagement part.

Further, in the water purifier, wherein the cock support engagement part has a cock contact part that closely contacts an end of the cock when the cock support engagement part is connected to the cock, and wherein the cock contact part includes: a first contact surface facing a lower surface of the cock; and a second contact surface extending in a circumferential direction to surround a lower end of the cock.

Further, in the water purifier, an O-ring disposed between the lower end of the cock and the second contact surface to seal a gap between the cock and the cock support member.

Further, in the water purifier, wherein the cock support body extends horizontally from the cock support engagement part, wherein the upper surface of the cock support body and the lower surface of the second housing closely contact each other, wherein the cock support engagement part closely contacts the cock, and wherein a contact area between the upper surface of the cock support body and the lower surface of the second housing is greater than a contact area between the cock support engagement part and the cock.

Further, in the water purifier, wherein the cock includes: a cock body; and a stopper protruding from the cock body to prevent the cock support member from rotating beyond a predetermined rotational phase angle or rising beyond a predetermined distance.

Further, in the water purifier, a protruding engagement part formed to engage with the cock support member; and a protrusion extending laterally from the cock body.

Further, in the water purifier, wherein the cock support member is configured to engage with the cock and the housing by being rotated.

Further, in the water purifier, wherein the cock support member, in a detached state from the cock and the housing, approaches the cock in a first position to closely contact at least one of the housing and the cock, and is rotated by a predetermined rotational phase angle from the first position to a second position to engage with the housing and the cock.

Further, in the water purifier, wherein a housing recess is formed in the second housing, and when the housing engagement part is disposed above the housing recess in the first position, the cock support member is allowed to be detached from the housing.

Further, in the water purifier, wherein the second housing has a hole portion through which the cock support member penetrates and the housing recess is formed, and wherein in a state where the cock support member is coupled to the housing, a shortest distance from one end of the cock support body to the cock support engagement part is greater than the horizontal gap size between the housing and the cock support member in the hole portion.

Further, in the water purifier, wherein the cock includes: a cock body; and a protrusion protruding laterally from the cock body, and including a protruding engagement part formed to engage with the cock support member, wherein a cockengagement part is formed in the cock support engagement part, and wherein the cock support member is allowed to be detached from the cock when the protrusion is disposed at the cock engagement part in the first position.

Further, in the water purifier, wherein an engagement slit is formed in the cock support engagement part, wherein the engagement slit engages with the protruding engagement part when the cock support member is rotated to the second position relative to the cock to engage with the cock, and wherein movement of the cock is restricted when the protruding engagement part is engaged in the engagement slit.

Further, in the water purifier, wherein the cock is integrally formed with the flow channel or is separately formed to be detachable from the flow channel.

### BRIEF DESCRIPTION OF THE DRAWINGS

FIG. 1 is a perspective view of a water purifier according to an embodiment of the present invention.

FIG. 2 is an exploded perspective view of the water purifier shown in FIG. 1.

FIG. 3 is a cross-sectional view taken along line III-III of FIG. 1.

FIG. 4 is an enlarged view of section A of FIG. 2.

FIG. 5 is a left-side perspective view of the cock support member.

FIG. 6 is a perspective view of the cock support member as seen from the rear of FIG. 5.

FIG. 7 is an enlarged view of section B of FIG. 3.

FIG. 8 is a front-side perspective view of the cock support member shown in FIG. 5.

FIG. 9 is a cross-sectional view taken along line IV-IV of FIG. 7.

FIG. 10 is an enlarged view of section D of FIG. 9.

FIG. 11 is a perspective view showing the cock and the cock support member in a detached state in FIG. 5.

FIG. 12 is an enlarged view of section C of FIG. 4.

### DETAILED DESCRIPTION

Hereinafter, specific embodiments for implementing the technical ideas of the present disclosure will be described in detail with reference to the drawings.

In addition, in describing the present disclosure, when it is determined that a detailed description of the relevant known configuration or function may obscure the gist of the present disclosure, the detailed description thereof will be omitted.

Further, when a component is mentioned to be “coupled to”, “supported by”, “connected to”, “supplied to”, “transferred to”, and “in contact with” another component, it should be understood that it may be directly coupled to, supported by, connected to, supplied to, transferred to, and in contact with another component, but there may be other components therebetween.

The terms used in the present specification are used merely to describe the specific embodiments and are not intended to limit the present disclosure. Singular expressions include the plural unless the context clearly indicates otherwise.

In addition, it should be noted in advance that in the present specification, expressions such as upper, lower, side, etc. are described based on the illustrations in the drawings, and may be expressed differently if the orientation of the subject is changed. For the same reason, in the accompanying drawings, some components are exaggerated, omitted, or schematically shown, and the size of each component does not entirely reflect the actual size.

Furthermore, the terms containing ordinal numbers, such as first, second, etc., may be used to describe various components, but the components are not limited by such terms. These terms are used only to distinguish one component from another.

The meaning of “include” used in the present specification is intended to specify certain features, areas, integers, steps, operations, elements, and/or components, and is not intended to exclude the existence or the addition of other specific features, areas, integers, steps, operations, elements, components, and/or groups.

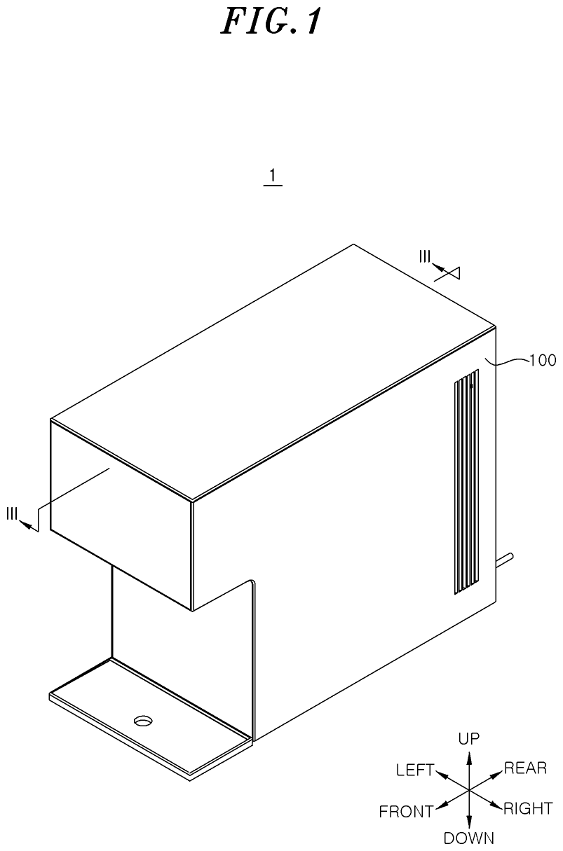

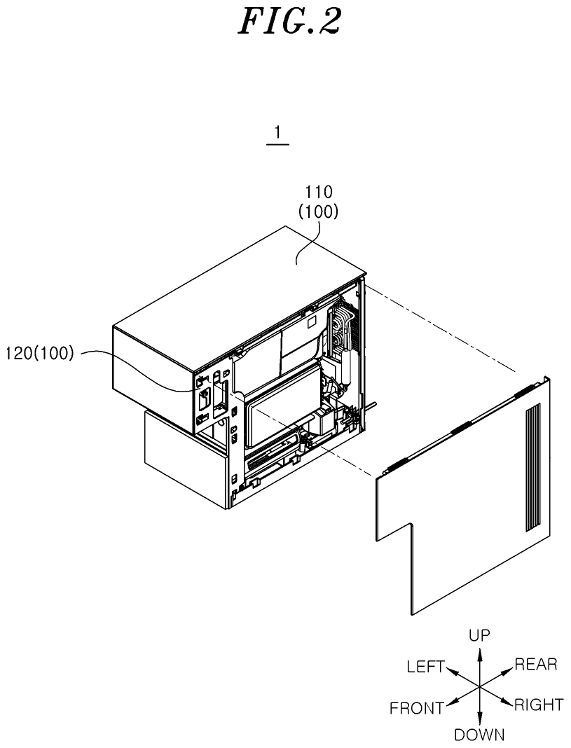

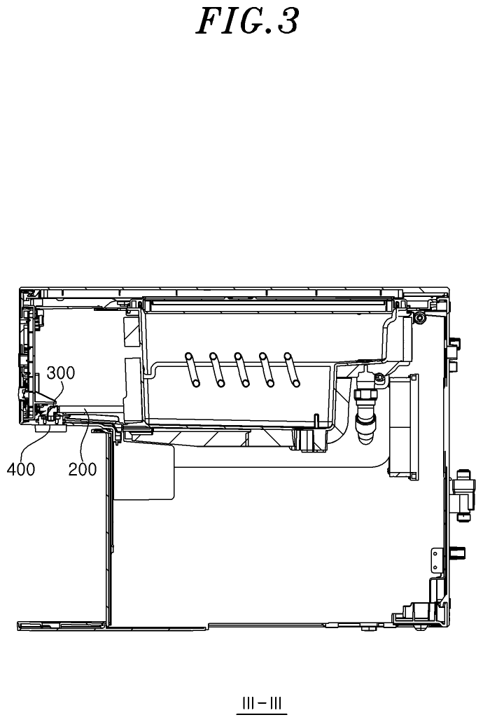

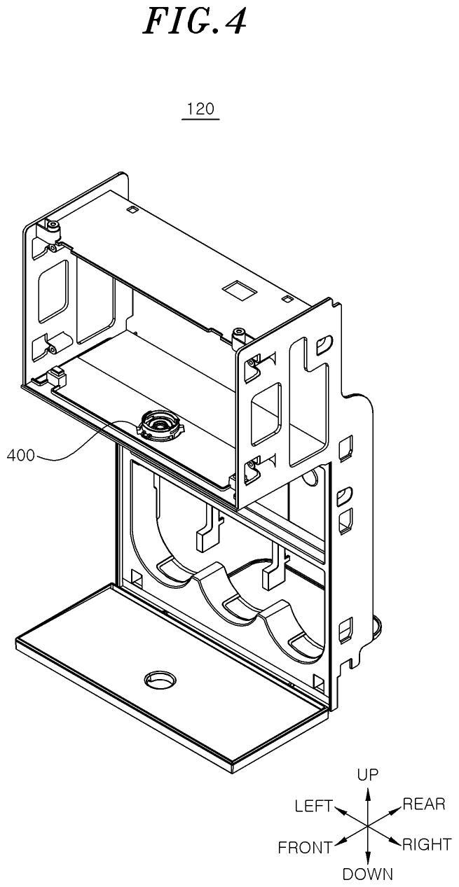

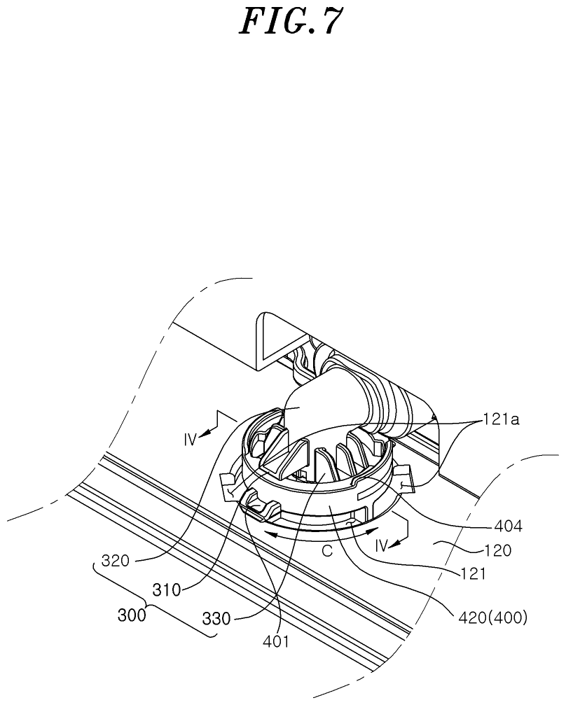

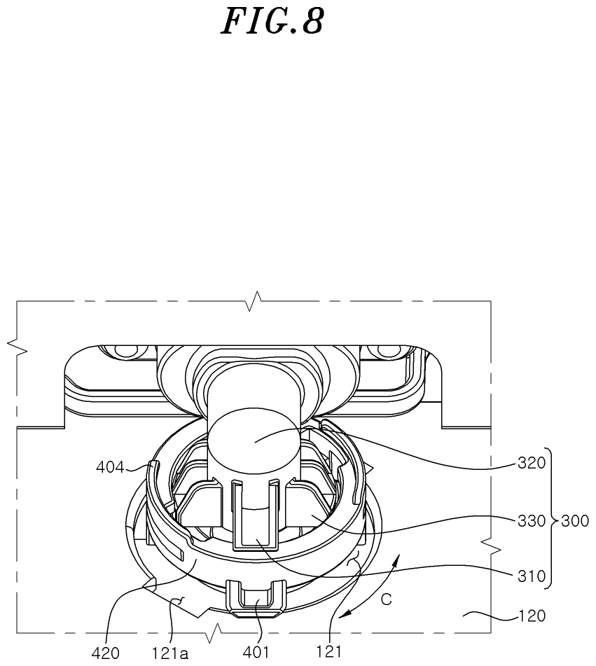

Hereinafter, the detailed configuration of a water purifier 1 according to an embodiment of the present invention will be described with reference to FIGS. 1 to 8.

The water purifier 1 according to an embodiment of the present invention can provide purified water to a user by filtering raw water. Raw water refers to water that has entered the water purifier 1 but has not passed through the filter, while purified water refers to water that has been filtered by the purification device. In addition, purified water may include cold water, which is cooled to a temperature below a certain threshold, and hot water, which exceeds a certain temperature. The water purifier 1 may include a housing 100, a filter unit (not shown), a flow channel 200, a valve unit (not shown), a cock 300, a cock support member 400, and an O-ring 500.

The housing 100 may accommodate at least one of the filter unit, the flow channel 200, and the valve unit. The housing 100 may include a frame that supports at least one of the filter unit, the flow channel 200, and the valve unit. The housing 100 may include a first housing 110 and a second housing 120.

The interior of the first housing 110 may accommodate a filter unit, the flow channel 200, and a valve unit. For example, the filter unit, the flow channel 200, and the valve unit may be disposed on the upper side of the first housing 110. The first housing 110 may be disposed on the rear side of the housing 100.

The second housing 120 may be disposed on the front side of the first housing 110 to support the cock 300. The second housing 120 may form the front face of the water purifier 1, and a display panel may be provided on the second housing 120. A hole portion 121 and a housing recess 121a may be formed in the second housing 120 for engaging the cock support member 400.

The hole portion 121 may be a hole formed in the second housing 120 to engage the cock support member 400. The cock support member 400 may penetrate the hole portion 121 to engage the cock 300. The housing recess 121a may be formed in the hole portion 121.

The housing recess 121a may be a concave groove formed in the second housing 120 to allow the cock support member 400 to engage. The housing recess 121a may include a plurality of housing recesses 121a, and the plurality of the housing recesses may be formed at the edges of the hole portion 121 through which a cock support engagement part 420 passes. For example, the housing recess 121a may have a U-shape when viewed from above. When a housing engagement part 401 to be described later, is disposed above the housing recess 121a, the cock support member 400 can be separated from the housing 100. After the housing engagement part 401 passes through the housing recess 121a and rotates to misalign with the housing recess 121a, the cock support member 400 is supported without being separated from the housing 100.

The flow channel 200 may provide a passage through which one or more of raw water and purified water flows. The cock 300 may be connected to the end of the flow channel 200. If the flow channel 200 is formed as a separate member from the cock 300, the end of the flow channel 200 may be coupled to the cock 300.

The cock 300 may discharge purified water to the outside. The cock 300 may include a stopper 310, a cock body 320, and a protrusion 330.

The stopper 310 may prevent the cock support member 400 from rotating beyond a predetermined rotational phase angle or from rising beyond a predetermined distance. The stopper 310 may protrude forward from the cock body 320. When the cock support member 400 is separated from the cock 300 and the housing 100, and approaches the cock 300 in a first position to be described later, a cock support body 410 comes into contact with the stopper 310, thereby preventing the cock support member 400 from rising. On the other hand, the stopper 310 may extend radially to prevent the cock support member 400 from rotating beyond a predetermined rotational phase angle when the cock support member 400 is inserted in the first position and rotated to the second position to be described later, by coming into contact with a projection 404 of a cock support engagement part 420, which will be described later.

The first position may refer to a position where the cock support member 400 is allowed to be either in close contact with or separated from the cock 300 and the housing 100. In other words, the cock support member 400 may come into close contact with the cock 300 and the housing 100 in the first position before being coupled to the cock 300 and the housing 100. Meanwhile, the second position refers to a position in which the cock support member 400 is engaged with the cock 300 and the housing 100 at a predetermined rotational phase angle by being rotated from the first position with the cock 300 and the housing 100 in close contact.

The cock body 320 may provide a passage for the purified water to flow out. The cock body 320 may be coupled to the end of the flow channel 200 from the rear and may form part of the flow channel 200. The cock body 320 may support the stopper 310 and the protrusion 330 at one end.

The protrusion 330 may protrude laterally from the cock body 320. The lateral direction refers to a horizontal direction perpendicular to the direction in which the cock support member 400 is coupled to or separated from the cock 300 and the housing 100. The protrusion 330 may include a plurality of protrusions 330. For example, an inclined surface may be formed on the protrusion 330 such that the length of the protrusion 330 in the lateral direction is longer at the lower side than at the upper side.

At the end of the protrusion 330, a protruding engagement part 331, which further protrudes in the lateral direction, may be formed. The protruding engagement part 331 may be formed at the lower portion of the protrusion 330. The protruding engagement part 331 may engage with an engagement slit 403 formed in the cock support member 400.

Meanwhile, although the cock 300 is shown as a separate member from the flow channel 200 in the drawings of the present embodiment, the present invention is not limited thereto, and the cock 300 may be integrally formed with the flow channel 200. In other words, the cock 300 may be provided as the end of the flow channel 200.

The cock support member 400 may support the cock 300. The coke support member 400 may engage with the coke 300 and the housing 100 in a detachable manner by being rotated. The cock support member 400 may have the housing engagement part 401, a cock engagement part 402, and the engagement slit 403. The cock support member 400 may include the cock support body 410 and the cock support engagement part 420.

The housing engagement part 401 may engage with the housing 100. The housing engagement part 401 may include a plurality of housing engagement parts 401 on the cock support engagement part 420. A plurality of housing engagement parts 401 may be symmetrically formed with respect to the cock support engagement part 420 to be described later. For example, the housing engagement part 401 may be disposed in positions symmetrically opposite with respect to a center of the cock support engagement part 420. When the housing engagement part 401 engages with the second housing 120, the cock support member 400 may be separated from the housing 100.

The cock engagement part 402 may guide the protruding engagement part 331 so that the protruding engagement part 331 engages with the engagement slit 403. The circumferential width of the cock engagement part 402 may be greater than the circumferential width of the protruding engagement part 331. Here, the circumferential width refers to the length in the circumferential direction (C) when viewed from above. When the protruding engagement part 331 is disposed in the cock engagement part 402, the cock support member 400 may be separated from the cock 300. In other words, when the protruding engagement part 331 is disposed in alignment with the cock engagement part 402, movement in the vertical direction of the protruding engagement part 331 is allowed, and the coupling of the cock support member 400 to the cock 300 may be released.

The engagement slit 403 engages with the protruding engagement part 331, coupling the cock 300 and the cock support member 400. The engagement slit 403 may be disposed below the cock engagement part 402 and extend continuously from the cock engagement part 402. When the protruding engagement part 331 is engaged in the engagement slit 403, the movement of the cock 300 may be restricted. Meanwhile, the circumferential width (C) of the engagement slit 403 may be greater than the circumferential width (C) of the protruding engagement part 331.

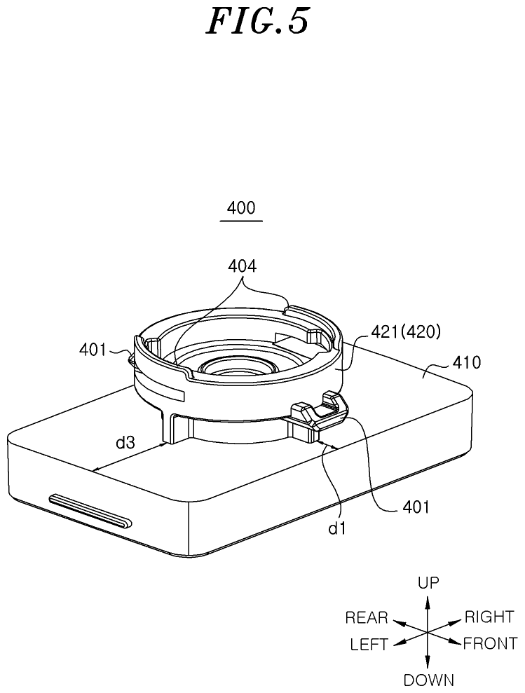

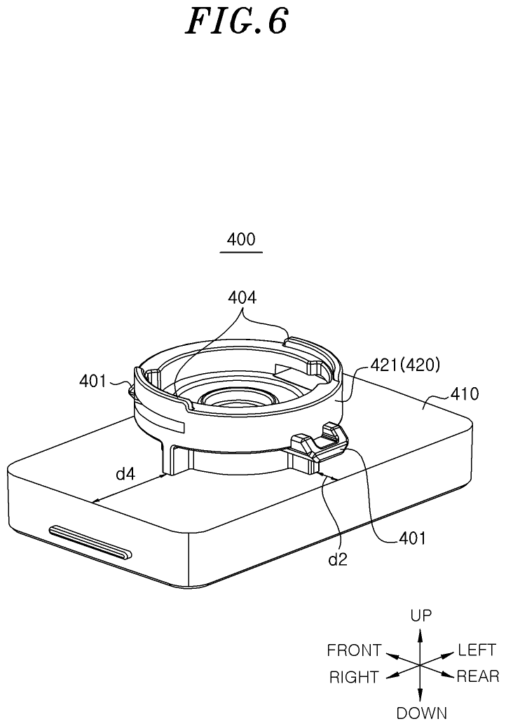

Referring to FIGS. 5 and 6 again, the cock support body 410 may support the cock support engagement part 420. The cock support body 410 may extend horizontally from the cock support engagement part 420. The cock support body 410 may, for example, have a rectangular parallelepiped shape. The cock support body 410 may have a greater left-right width than the front-rear width, and the front-rear width may be greater than the top-bottom width, based on when the cock support member 400 is in the second position. When the cock support member 400 is coupled to the housing 100, the cock support body 410 may be disposed under the second housing 120. When the cock support member 400 is coupled to the housing 100, the upper surface of the cock support body 410 may closely contact the lower surface of the second housing 120, except for the area of the horizontal plane where the hole portion 121 is located. In the state where the cock support member 400 is coupled to the housing 100, the size of the area of the upper surface of the cock support body 410 projected vertically upwards to the second housing 120 may be larger than the hole portion 121.

In the state where the cock support member 400 is coupled to the housing 100, the shortest distance from one end of the cock support body 410 to the cock support engagement part 420 may be greater than the horizontal gap size between the housing 100 and the cock support member 400 at the hole portion 121. For example, when the cock support member 400 is coupled to the housing 100, at least one of the shortest rearward distance (d1) from the front end of the cock support body 410 to the cock support engagement part 420, the shortest forward distance (d2) from the rear end of the cock support body 410 to the cock support engagement part 420, the shortest left-right distance (d3) from the left end of the cock support body 410 to the cock support engagement part 420, and the shortest left-right distance (d4) from the right end of the cock support body 410 to the cock support engagement part 420, may be greater than the horizontal gap size between the housing 100 and the cock support member 400 at the hole portion 121.

The cock support engagement part 420 may closely contact the cock 300. The cock support engagement part 420 may be supported at the upper side of the cock support body 410. The cock support engagement part 420 may include a cock support peripheral part 421 and the cock contact part 422.

The cock support peripheral part 421 may be the radially outer portion of the cock support engagement part 420. The cock support peripheral part 421 may have a plurality of projections 404. On the radially inner side of the cock support peripheral part 421, the cock engagement part 402 and the engagement slit 403 may be formed. In the first position, when the cock support peripheral part 421 contacts the stopper 310, the upward movement of the cock support member 400 can be restricted.

The cock contact part 422 may closely contact the end of the cock 300 when the cock 300 is connected. The cock contact part 422 may include a first contact surface 422-1 and a second contact surface 422-2.

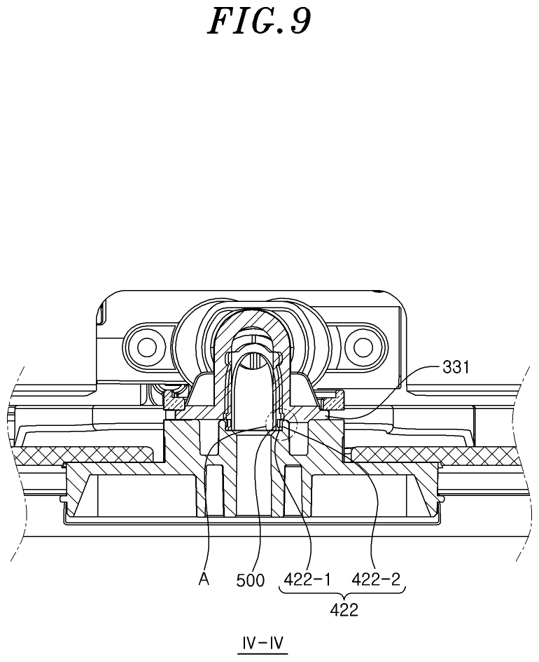

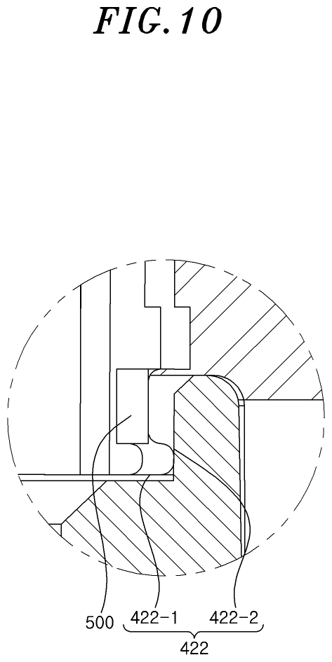

Hereinafter, referring to FIGS. 9 and 10, the first contact surface 422-1 and the second contact surface 422-2 are explained. The first contact surface 422-1 may be formed to face the lower end of the cock 300. The first contact surface 422-1 may be flat in the horizontal direction. The first contact surface 422-1 may, for example, be formed in a donut shape along the cock body 320.

The second contact surface 422-2 may extend circumferentially (C) to surround the lower end of the cock 300. The second contact surface 422-2 may extend upward with respect to the first contact surface 422-1. The second contact surface 422-2 may form a right angle with the first contact surface 422-1.

The O-ring 500 may provide a tighter seal for the gap between the cock 300 and the cock support member 400. The O-ring 500 may, for example, be made of rubber. The O-ring 500 may be disposed between the lower end of the cock 300 and the second contact surface 422-2 to seal the gap between the cock 300 and the cock support member 400. The horizontal width of the O-ring 500 may be the distance between the cock 300 and the first contact surface 422-1, and the vertical width may be the distance between the cock 300 and the second contact surface 422-2.

Meanwhile, although the O-ring 500 is shown as being provided in the drawings of this embodiment, the scope of the present invention is not necessarily limited to this, and the O-ring 500 may be omitted.

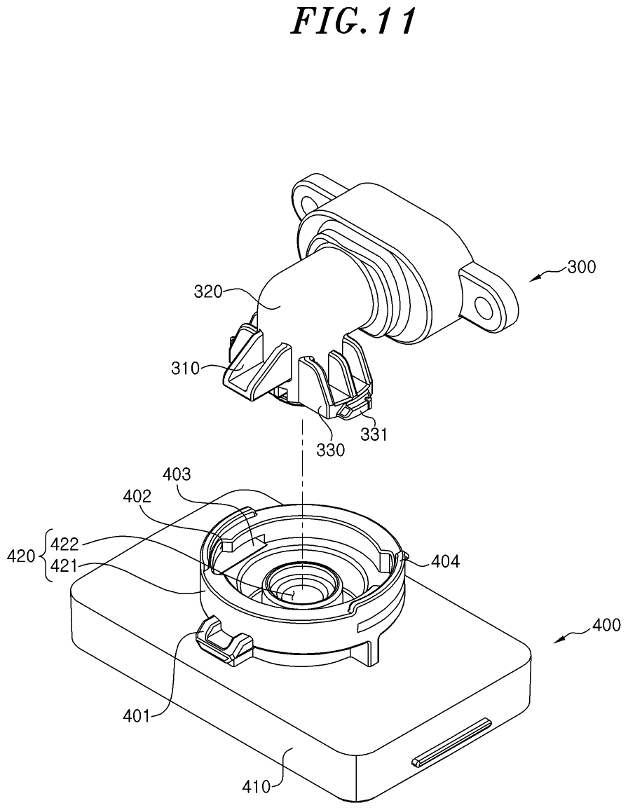

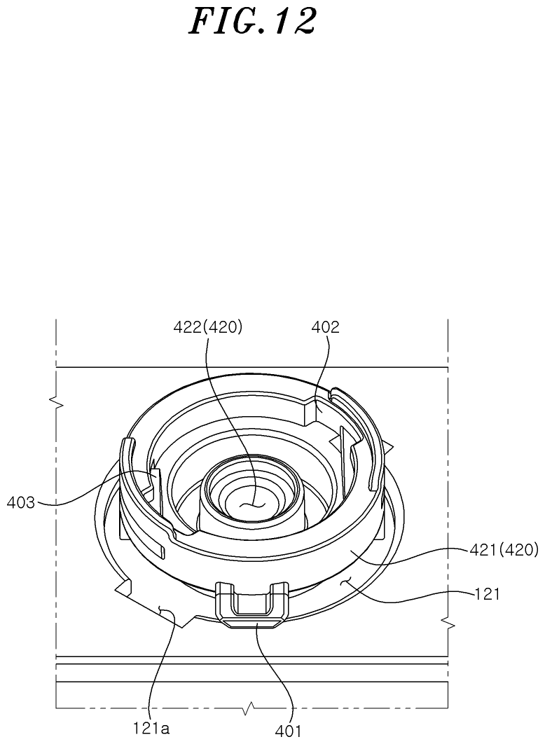

Hereinafter, referring to FIGS. 11 and 12, the operation and effects of the cock support member 400 having the configuration described above are explained.

The cock support member 400, in the state where the cock support member 400 is separated from the cock 300 and the housing 100 in the first position and may closely contact at least one of the housing 100 and the cock 300. For example, in the first position, the stopper 310 is disposed above the cock support peripheral part 421, and the cock engagement part 402 is disposed above the protruding engagement part 331, thereby allowing the cock support member 400 to closely contact the cock 300. In other words, the cock engagement part 402 may be disposed radially outward relative to the protrusion 330.

The cock support member 400 may be rotated by the predetermined rotational phase angle to change from the first position to the second position and engage with the housing 100 and the cock 300. The second position may be a position where the cock 300 and the cock support member 400 are engaged such that the cock 300 and the cock support member 400 do not separate each other. In other words, in the second position, the protruding engagement part 331 is engaged in the engagement slit 403, and the protrusion 330 is offset from the cock engagement part 402.

Meanwhile, the cock support member 400 may be inserted into the second housing 120 and then coupled to the cock 300. The housing engagement part 401 passes through the housing recess 121a and is inserted into the second housing 120 in the first position, engaging the second housing 120, and after the cock contact part 422 of the cock support member 400 closely contacts the cock 300, the cock contact part 422 rotates by a predetermined phase angle to reach the second position, allowing the cock support member 400 to be coupled to the cock 300. In other words, when the housing engagement part 401 interferes with the second housing 120 by not being disposed above the housing recess 121a, the cock support member 400 may maintain in the second position coupled to the second housing 120.

The upper surface of the cock support member 400 closely contacts the second housing 120 upwardly, and the side surface of the cock support engagement part 420 closely contacts the O-ring 500 or the cock 300 laterally. Since the cock support member 400 is forcibly fitted into the second housing 120 and the cock 300 so that the direction of the repulsive force applied from the second housing 120 by being in close contact with the second housing 120 and the direction of the repulsive force applied from the cock 300 by being in close contact with the cock 300 face are opposite to each other, the cock support member 400 may be in closer contact with the second housing 120 and the cock 300. For example, the cock support member 400 receives a downward repulsive force from the second housing 120 when the cock support member 400 is in close contact with the second housing 120, and a upward repulsive force from the cock 300 when the cock support member 400 is in close contact with the cock 300, so that one of the close contact with the second housing 120 and the close contact with the cock 300 may be stably maintained.

Additionally, since the cock support member 400 closely contacts the bottom of the second housing 120 over a wide area, the hole portion 121 and the housing recess 121a can be formed with more space. Since the cock support member 400 closely contacts the bottom of the second housing 120 over a wide area, sensitivity to external factors can be decrease. Moreover, even if the cock support member 400 and the cock 300 in a slightly misaligned state in the first position, the cock support member 400 and the cock 300 can be easily engaged to each other.

Additionally, since the cock support member 400 closely contacts a wide surface area of the bottom of the second housing 120, the inflow of steam can be blocked, even if small foreign substances are caught between the cock support member 400 and the second housing 120.

The above describes the coupling of the cock support member 400 to the cock 300 and the housing 100, and by proceeding in reverse order, the cock support member 400 can be separated from the cock 300 and the housing 100.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A water purifier comprising:
a filter unit that filters raw water to provide purified water;
a flow channel that provides a passage through which the raw water or the purified water flows;
a valve unit including at least one valve module that is selectively opened and closed to control a flow of the raw water or the purified water in the flow channel;
a cock for discharging the purified water to an outside of the water purifier;
a housing including a first housing in which the filter unit, the flow channel, and the valve unit are accommodated, and a second housing disposed on a front side of the first housing; and
a cock support member that is detachably engaged with the cock and the housing.

2. The water purifier of claim 1, wherein the cock support member includes:
a cock support body; and
a cock support engagement part supported by the cock support body and having a housing engagement part that is formed to engage with the second housing, wherein the cock support body closely contacts the second housing when the second housing engages with the housing engagement part.

3. The water purifier of claim 2,
wherein the cock support engagement part has a cock contact part that closely contacts an end of the cock when the cock support engagement part is connected to the cock, and
wherein the cock contact part includes:
a first contact surface facing a lower surface of the cock; and
a second contact surface extending in a circumferential direction to surround a lower end of the cock.

4. The water purifier of claim 3, further comprising an O-ring disposed between the lower end of the cock and the second contact surface to seal a gap between the cock and the cock support member.

5. The water purifier of claim 2,
wherein the cock support body extends horizontally from the cock support engagement part,
wherein the upper surface of the cock support body and the lower surface of the second housing closely contact each other,
wherein the cock support engagement part closely contacts the cock, and
wherein a contact area between the upper surface of the cock support body and the lower surface of the second housing is greater than a contact area between the cock support engagement part and the cock.

6. The water purifier of claim 2, wherein the cock includes:
a cock body; and
a stopper protruding from the cock body to prevent the cock support member from rotating beyond a predetermined rotational phase angle or rising beyond a predetermined distance.

7. The water purifier of claim 6, wherein the cock includes a protrusion extending laterally from the cock body and comprising a protruding engagement part formed to engage with the cock support member.

8. The water purifier of claim 2,
wherein the cock support member is configured to engage with the cock and the housing by being rotated.

9. The water purifier of claim 8,
wherein the cock support member, in a detached state from the cock and the housing, approaches the cock in a first position to closely contact at least one of the housing and the cock,
and is rotated by a predetermined rotational phase angle from the first position to a second position to engage with the housing and the cock.

10. The water purifier of claim 9,
wherein a housing recess is formed in the second housing,
and when the housing engagement part is disposed above the housing recess in the first position, the cock support member is allowed to be detached from the housing.

11. The water purifier of claim 10,
wherein the second housing has a hole portion through which the cock support member penetrates and the housing recess is formed, and
wherein in a state where the cock support member is coupled to the housing, a shortest distance from one end of the cock support body to the cock support engagement part is greater than the horizontal gap size between the housing and the cock support member in the hole portion.

12. The water purifier of claim 10, wherein the cock includes:
a cock body; and
a protrusion protruding laterally from the cock body and comprising a protruding engagement part formed to engage with the cock support member,
wherein a cock engagement part is formed in the cock support engagement part, and wherein the cock support member is allowed to be detached from the cock when the protrusion is disposed at the cock engagement part in the first position.

13. The water purifier of claim 12, wherein an engagement slit is formed in the cock support engagement part,
wherein the engagement slit engages with the protruding engagement part when the cock support member is rotated to the second position relative to the cock to engage with the cock, and
wherein movement of the cock is restricted when the protruding engagement part is engaged in the engagement slit.

14. The water purifier of claim 1,
wherein the cock is integrally formed with the flow channel or is separately formed to be detachable from the flow channel.
